(19) United States
(12) Patent Application Publication
(10) Pub. No.: US 2023/0036475 A1
(43) Pub. Date: Feb. 2, 2023

(54) LOCAL NAVIGATION ASSISTED BY VEHICLE-TO-EVERYTHING (V2X)

(71) Applicant: QUALCOMM Incorporated, San Diego, CA (US)

(72) Inventors: Lan YU, Beijing (CN); Shailesh PATIL, San Diego, CA (US); Hong CHENG, Basking Ridge, NJ (US); Dan VASSILOVSKI, Del Mar, CA (US); Gene Wesley MARSH, San Diego, CA (US)

(21) Appl. No.: 17/757,385

(22) PCT Filed: Jan. 17, 2020
(86) PCT No.: PCT/CN2020/072778

§ 371 Date: Jun. 15, 2022

(51) Int. Cl. G08G 1/0968; G01C 21/34

(52) U.S. Cl. CPC G08G 1/096811; G08G 1/096883; G01C 21/3492; G01C 21/3469; H04W 4/40

(57) ABSTRACT

Techniques described herein provide for enhanced ultra-local navigation services for V2X devices (e.g., smartphones incorporating V2X chip sets). The V2X devices can transmit vehicle information to edge network devices (e.g., roadside units). The roadside units can be deployed at intersections or along roads to collect traffic information through various sensor inputs and V2X communications with multiple vehicles. The communication between V2X devices and the edge network devices can be accomplished through wireless communication (e.g., direct PC5 interface or through local Uu interface with edge computing. The edge network devices can perform local route optimization and compute one or more recommendations (e.g., a recommend route, a recommended speed, a recommended lane). The edge network devices can transmit the one or more recommendations via a wireless communication to the V2X devices. The V2X devices can display the recommendations to a user.

### BACKGROUND

Existing navigation applications focus on macro-level route planning, performing traffic evaluation and prediction for a large number of users. The algorithms for these pre-existing systems do not analyze details of the local traffic environment, for instance, the local event at intersections and traffic light phase (TLP). Micro-level management is unrealistic for existing navigation solutions because of the latency for event reporting and processing delays in the cloud or application server.

Vehicle-to-everything (V2X) is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly-termed road-side units (RSUs)), vehicle-to-person (V2P) communication between vehicles and nearby people (pedestrians, cyclists, and other road users), and the like. Further, V2X can use any of a variety of wireless radio frequency (RF) communication technologies. Cellular V2X (CV2X), for example, is a form of V2X that uses cellular-based communication such as long-term evolution (LTE), fifth generation new radio (5G NR), and/or other cellular technologies in a direct-communication mode as defined by the 3rd Generation Partnership Project (3GPP). A component or device on a vehicle, RSU, or other V2X entity that is used to communicate V2X messages is generically referred to as a V2X device or V2X user equipment (UE).

V2X capabilities can be used for enhanced navigation systems as described herein.

### BRIEF SUMMARY

Techniques described herein provide for enhanced ultra-local navigation services for V2X devices (e.g., smartphones incorporating V2X chip sets). The V2X devices can transmit vehicle information to edge network devices (e.g., roadside units). The roadside units can be deployed at intersections or along roads to collect traffic information through various sensor inputs and V2X communications with multiple vehicles. The communication between V2X devices and the edge network devices can be accomplished through wireless communication (e.g., direct PC5 interface or through local Uu interface with edge computing. The edge network devices can perform local route optimization and compute one or more recommendations (e.g., a recommend route, a recommended speed, a recommended lane). The edge network devices can transmit the one or more recommendations via a wireless communication to the V2X devices. The V2X devices can display the recommendations to a user.

These and other embodiments are described in detail below. For example, other embodiments are directed to systems, devices, and computer readable media associated with methods described herein.

A better understanding of the nature and advantages of embodiments of the present disclosed may be gained with reference to the following detailed description and the accompanying drawings.

### BRIEF DESCRIPTION OF THE DRAWINGS

FIG. 1 illustrates existing navigation techniques.

FIG. 2 illustrates enhanced navigation techniques using V2X devices.

FIG. 3 illustrates an exemplary diagram of a technique for lane recommendation.

FIG. 4 illustrates an exemplary diagram of a technique for route recommendation.

FIG. 5 is a flow diagram of a method for enhanced navigation techniques according to embodiment.

FIG. 6 illustrates a process flow diagram of a method for enhanced navigation techniques.

FIG. 7 is an exemplary block diagram of a basic architecture of components used to for enhanced navigation techniques

FIG. 8 is a block diagram of an embodiment of a V2X device.

Like reference, symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc., or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

As referred to herein, “V2X devices,” “V2X vehicles,” and “V2X entities” respectively refer to devices, vehicles, and entities capable of transmitting and receiving V2X messages. Similarly, “non-V2X vehicles” and “non-V2X entities” refer to vehicles and entities that do not or cannot engage in V2X communications. Although many embodiments described “V2X vehicles” and “non-V2X vehicles,” it will be understood that many embodiments can be expanded to include non-vehicle entities, such as pedestrians, cyclists, road hazards, obstructions, and/or other traffic-related objects etc. As generally referred to herein, the “objects” detected by sensors as described in the embodiments herein may refer to detected vehicles or non-vehicle objects, which may be on or near the road. Additionally, although embodiments herein are directed toward V2X enhanced navigation techniques, it will be understood that alternative embodiments may be directed toward alternative forms of traffic-related communication. A person of ordinary skill in the art will appreciate such variations.

In V2X communication, data transmitted by one V2X device may be relevant only to V2X devices within a certain distance of the transmitting V2X device. For example, vehicles attempting to traverse an intersection may only find data relevant within a certain proximity to the intersection. Similarly, for vehicles participating in coordinated driving, only vehicles affected by a maneuver may find the data relevant.

As noted, V2X (under 5G NR) supports distanced-based communication control. More specifically, if a receiving V2X device within a specified distance (referred to herein as the “V2X communication range” or simply “communication range”) receives a V2X message from a transmitting V2X device, the receiving V2X device will transmit a negative acknowledgement (NAK) if it is within the specified range, but has failed to decode the message. This allows the transmitting V2X device to retransmit the message. Through this mechanism, the reception reliability of V2X is increased for V2X devices within the specified range, enhancing performance for device maneuvers relying on the underlying V2X communication.

Additionally, V2X-capable devices may be knowledgeable of the location and motion state of other V2X vehicles, as well as non-V2X vehicles (and other objects) in their vicinity. For the former, this may be determined by reception of message or signaling from other V2X devices, for example, control signaling indicating V2X device's or vehicle's location, Basic Safety message (BSM) or Cooperative Awareness Message (CAM). For the latter, this may be determined by on-board sensors capable of detecting the motion state and/or other properties of the non-V2X vehicles and other objects.

Embodiments provided herein leverage this ability of a V2X device to use on-board sensors to determine properties of non-V2X vehicles and other objects to dynamically determine a communication range for a V2X message. In some embodiments, for example, a V2X device can determine one or more properties of a detected object and increase the communication range for a V2X message based on the one or more properties, to help inform nearby V2X devices of the one or more properties of the detected object. This additional information can alert nearby V2X devices of any conditions that made need to be taken into account to ensure user safety. Embodiments are described below, in reference to the accompanying figures.

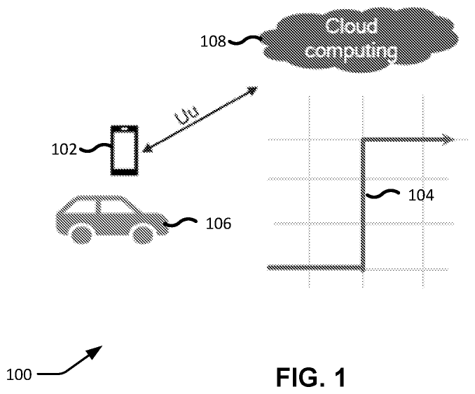

FIG. 1 illustrates an exemplary embodiment of existing navigation network 100. According to existing navigation techniques 100, navigation applications on electronic devices 102 (e.g., a smartphone, a tablet, a wearable device) provide route 104 recommendation for a vehicle 106 and travel time estimates via the electronic devices 102. Generally, in existing navigation network 100 the application designer uses a centralized mechanism for service. The centralized mechanism can be performed using cloud-computing 108 in a remote server reached through a network (e.g., the Internet). Communications between the electronic devices 102 and the cloud computing 108 can be accomplished through wired or wireless means. In various embodiments, the communication can be accomplished through a Uu connection.

Existing navigation techniques 100 can provide near real-time and historical data from crowdsourcing reports and sensor data sent to the cloud computing 108. The cloud computing 108 can perform data aggregation and analyzation for route optimization using one or more algorithms. The cloud computing 108 can provide feedback to users with driving assistance information. If the driver provides a destination, the clouding computing 108 can provide a best route to the driver via the wireless network.

However, the cloud computing 108 is not generally located in the vicinity to the electronic devices 102. In addition, the cloud computing 108 can be required to process requests from thousands or millions of electronic devices. Therefore, the services provides by remote cloud computing 108 systems generally only provide macro-level route selection and rough estimates of travel time based on traffic volume evaluation. Therefore, it is difficult to meet specific navigation requirements for individual vehicles. In addition, the latency inherent in remote cloud systems for processing local traffic data can result in inaccurate or unresponsive results when coupling with local events.

A distributed system of edge network devices that can perform the crowdsourcing of vehicle information and traffic data can reduce any the latency and result in highly responsive recommendations.

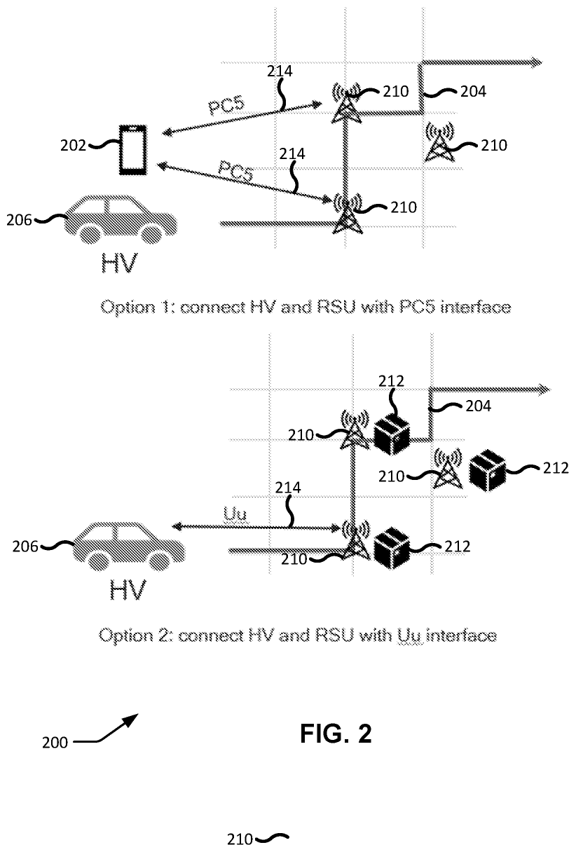

FIG. 2 illustrates an enhanced navigation network 200. In the enhanced navigation network, the electronic device 202 is a V2X device. A plurality of edge network devices 210 (e.g., roadside units) are distributed throughout the area. The edge network devices 210 can communicate with one or more electronic devices 202 via a wireless communication link 214 (e.g., PC5 link or a Uu link). The electronic device 202 can receive vehicle information (e.g., speed, acceleration, geographic location) from the vehicle 206. The electronic device 202 can transmit this information over the wireless communication link 214 to one or more edge network devices 210. The edge network devices 210 can receive the vehicle information from multiple V2X equipped devices. The edge network devices 210 can also receive other information to include traffic, weather, event, and incident information. The messages exchanged for navigation via V2X devices, between vehicles and edge network devices will be standardized in the application-layer standards, such as SAE International and ETSI-ITS standards.

In some embodiments, the edge network devices 210 may be equipped with a Uu interface. The Uu interface is a the radio connection between the mobile device and the radio access network. In various embodiments, the Uu interface is called UMTS Terrestrial Radio Access (UTRA). This interface is part of ITU's IMT-2000. In the currently most popular variant for cellular mobile telephones, W-CDMA (IMT Direct Spread) is used. However, the Uu interface is not limited to these 3G descriptions. It is also called “Uu interface,” as it links User Equipment to the UMTS Terrestrial Radio Access Network. The Uu interface can be used to connect users and edge network devices 210 (e.g., local base stations with edge computing functions).

The enhanced navigation network 200 significantly reduces latency. First, the edge network devices 210 sense road condition and events directly instead of an application server (cloud computing 108, as shown in FIG. 1) relying on global crowdsourced data for determination. Second, the edge network devices 210 collect instant traffic conditions from users and can perform local navigation algorithms with less latency than with cloud computing 108. Third, the edge network devices 210 instantly deliver optimal route and lane-level driving recommendations to users instead of the cloud disseminating instructions to a base station to be further transmitted to smartphone users.

Edge network devices 210 are communication nodes for vehicular communication systems. The edge network devices 210 provide electronic devices 202 with information, such as safety warnings and traffic information. They can be effective in avoiding accidents and traffic congestion. In various embodiments, edge network devices 210 are dedicated short-range communications (DSRC) devices. However, the disclosure is not limited to direct vehicle communications based on 802.11. In various embodiments the edge network devices operate in 5.9 GHz band with bandwidth of 75 MHz and approximate range of 300 meters. Vehicular communications is usually developed as a part of intelligent transportation systems (ITS).

V2X device assisted navigation can provide micro-level navigation service based on edge network device 210 assistance. The edge network devices 210 perform driving strategy optimization for surrounding V2X users. From sensors and V2I communication with smartphones, the edge network devices 210 collect regular traffic information such as road average speed, intersection crossing time, traffic volume, and individual vehicle information such as geographic location, speed, destination of users, etc.

V2X device assisted navigation can provide both local optimization and configurable global optimization. According to road conditions and traffic light phase (TLP), the edge network device 210 can calculate a recommended speed to transmit to a driver to reduce unnecessary wait at traffic signals.

For unexpected events (e.g., traffic collisions or weather events), the edge computing devices 210 can detect events immediately and transmit corresponding route recommendations to influenced V2X users to avoid unnecessary delays.

The edge network devices 210 can access traffic light information not limited to the intersection edge network device 210 allowing for calculation of sequential upcoming TLP for route selection and timing calculations.

The edge network devices 210 can compute optimal routes for vehicles based on TLP at multiple intersections and average road speed estimates.

In some embodiments, the electronic device 202 can be a smartphone deployed with a V2X chipset to provide motion information and driving intention to assist strategy settings of the edge network devices 210. Smartphones with V2X chipsets can access motion and sensor data of an associated vehicle through wired or wireless connection. If there is no direct connection to the vehicle, smartphones with sensors and GPS can provide information such as geographic location, speed, acceleration for calculations of recommended route, recommended speed, and recommended lane.

With a PC5 connection, near real-time motion state of vehicle can be broadcast periodically to all V2X devices including edge network devices 210 and other vehicles within message coverage areas. With Uu connections, the vehicle information can be transmitted to associated edge network devices 210. Vehicle intention (e.g., driving destination, desired directions, or lane change intentions) can be transmitted via a wireless link to the edge network device 210.

In some embodiments, the electronic device 202 can include a V2X application that can receive user inputs for route selection to meet individual driver requirements. For example, the V2X app can calculate optimized traveling time. The optimized traveling time can reduce overall driving time or reduce waiting time. The V2X app can calculate a route to optimize fuel consumption. For example, frequent speed changes can cause unnecessary fuel loss. The V2X app can calculate a recommended speed for optimal fuel consumption for the route. In some embodiments, the V2X app can calculate a compromised solution by applying configurable weights of driving time, waiting time, and fuel consumption.

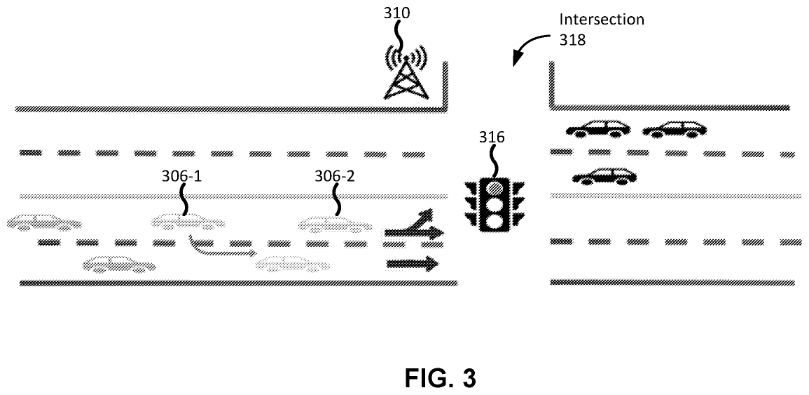

FIG. 3 is a diagram providing an overhead view of a traffic intersection 318, provided to help illustrate how V2X communication can be used by vehicles 306-1, 306-2 (collectively and generically referred to herein as vehicles 306) to provide useful information that can be used by vehicles 306 to help ensure the safety of passengers therein. It will be understood that FIG. 3, as with other figures provided herein, is provided as a non-limiting example. As a person of ordinary skill in the art will appreciate, the number of scenarios in which V2X communication can be useful extend far beyond this example. See scenarios can include more or fewer vehicles, different types of vehicles, as well as non-vehicle entities (RSUs, Vulnerable Road Users (VRUs), road hazards and other objects, and the like, which may or may not be capable of V2X communication).

Here, each vehicle 306 is approaching the intersection 318. As vehicles approach the intersection 318, it can be helpful for each vehicle 306 to know the speed, direction, and location of each of the other vehicles, to help ensure safe navigation through the intersection 318. Ultimately, an intersection 318 may manage traversal of vehicles using V2X communication, either with a dedicated RSU, or among the vehicles 306 themselves. However, even without such management, this awareness of the properties of other vehicles 306 can help vehicles (e.g., autonomous and/or semi-autonomous vehicles) and/or their drivers navigate through the intersection 318 safely.

FIG. 3 illustrates the speed and lane recommendation features of an enhanced navigation system. FIG. 3 illustrates a multi-lane divided roadway with two lanes in each direction. A traffic signal 316 is illustrated at an intersection 318 between the multi-lane divided roadway and a second roadway. The driving intentions of vehicles can be transmitted to the edge network device 310. For example, the destination of vehicle 306-1 can be transmitted to the edge network device 310. In this example, the destination of vehicle 306-1 would be such that the vehicle 306-1 should travel straight through the intersection 318. The edge network device 310 can detect that the intention of vehicle 306-2 is to make a left turn at the intersection 318. Therefore, the edge network device 310 will determine the vehicle 306-1 would be delayed behind vehicle 306-2 if it remained in the left lane because it would need to wait for 306-2 to have clearance for a turn.

The edge network device 310 deployed at the intersection can detect local events and send lane recommendations to the electronic device 202 in vehicle 306-1. In the example, the edge network device 310 would recommend changing lanes to the right lane to enable vehicle 306-1 to travel straight through the intersection.

In addition to lane recommendation, the edge network device 310 can recommend a speed setting to avoid an unnecessary delay by the traffic signals. With the TLP information and the estimated average speed of traffic, the edge network device 310 can calculate optimum speed for vehicles to cross the intersection 318 without having to stop.

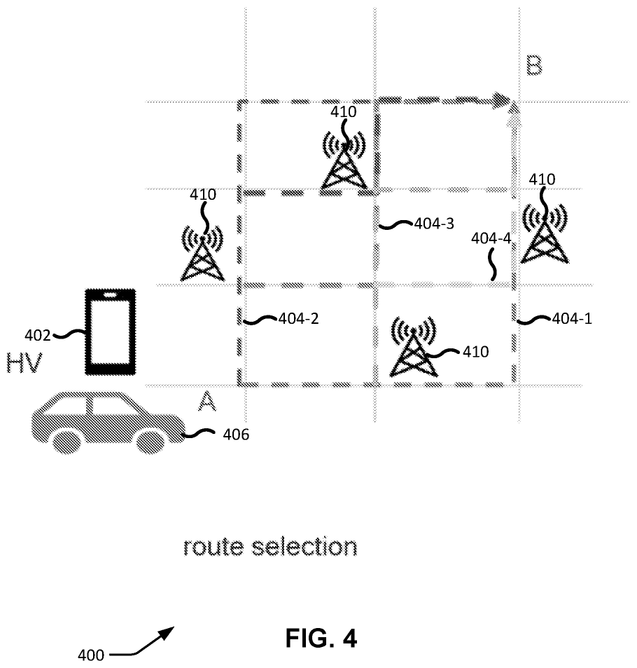

FIG. 4 illustrates a route selection calculation for a multiple-intersection scenario. FIG. 4 depicts a vehicle 406 traveling from point A to point B. There are four possible routes 404 depicted (e.g., 404-1, 404-2, 404-3, and 404-4). The electronic device 402 can transmit the vehicle information including the destination (point B). The vehicle information can be received by one or mode edge network devices 410.

The edge network devices 410 can calculate the traveling time, waiting time, and fuel consumption for all routes to destination at point B. The edge network device can determine traveling time of every road segment based on near real-time speed of traffic reported from vehicles along the route and traffic volume predictions. The edge network devices 410 can determine waiting times of every intersection based on arriving times predicted and TLP. The total fuel consumption can be estimated by speed and time predictions. The edge network devices 410 can update the optimum routes periodically or following unexpected events (e.g., a traffic collision or a weather event (e.g., flooding) along the route. The route recommendation and speed recommendation can be sent to the electronic devices 402.

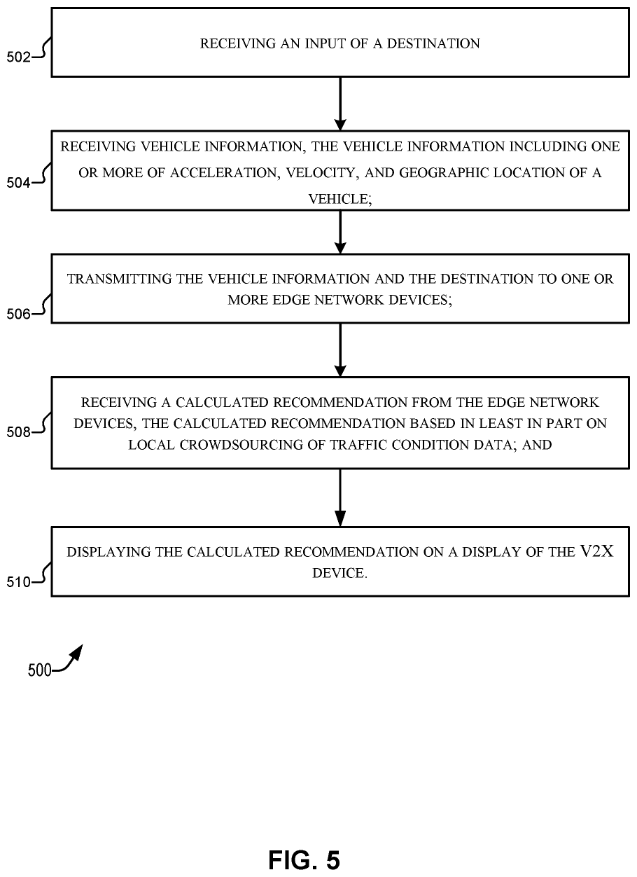

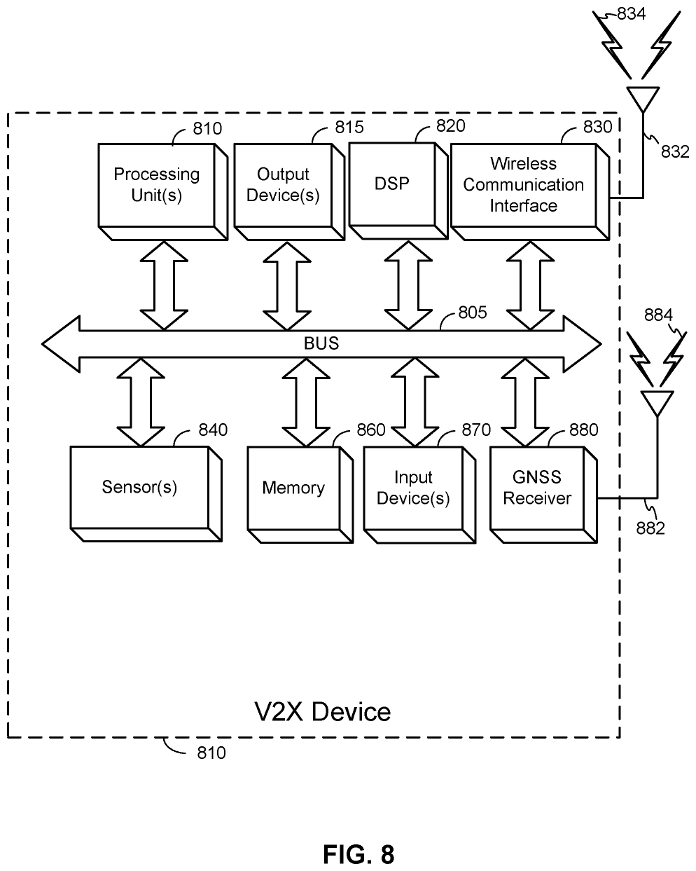

FIG. 5 illustrates a process flow diagram of a method 500 for enhanced navigation techniques according to various embodiments. Alternative embodiments may vary in function by combining, separating, or otherwise varying the functionality described in the blocks illustrated in FIG. 5. Means for performing the functionality of one or more of the blocks illustrated in FIG. 5 may comprise hardware and/or software components of a V2X device, such as the V2X device 810 illustrated in FIG. 8 and described below.

At 502, the functionality comprises receiving an input of a destination. In some embodiments, the destination may be entered via a touch screen display of an electronic device. In some embodiments, the destination may be selected from a list of one or more stored destinations stored in a memory of the device. In some embodiments, the destination may be selected from selecting an address listed on screen (e.g., an address of a location on a website). In some embodiments, the destination may be received by a voice command received on microphone on the electronic device. The destination can be stored in memory of the electronic device. In some embodiments, the destination can be inferred from one or more previous destinations.

At 504, the functionality comprises receiving vehicle information. The vehicle information can include one or more of acceleration, velocity, and geographic location of the vehicle. In some embodiments, the electronic device comprises a V2X chip module. The V2X chip module can capture motion information and sensor data of the vehicle through a wired or wireless connection. In some embodiments, the turn signal and braking signal can be received by the electronic device. If there is no direct connection between the electronic device and the vehicle, the geographic location, speed, and acceleration can be captured by one or more sensors on the electronic device (e.g., a smartphone). For example, the GPS sensors can calculate a geographic location of the electronic device (and therefore the location of the vehicle).

At 506, the functionality comprises transmitting the vehicle information and destination to one or more edge network devices (e.g., roadside units). The vehicle information can be transmitted via a wireless link. In some embodiments, the wireless link is a PC5 connection in which near real-time motion state of the vehicle is broadcast periodically to at V2X devices including edge network devices and other vehicles in message coverage. In some embodiments, the wireless link is a Uu connect in which vehicle stats are transmitted to an associated edge network device.

The edge network device can receive the vehicle information and destination. The edge network devices can also receive vehicle information and destination information from other V2X devices. The edge network device can receive traffic, incident, emergency, and weather information from wired and wireless links. The edge network device can crowdsourced the received information to generate one or more recommendations to the V2X devices. The one or more recommendations can include a recommended route (of a plurality of possible routes), a recommended speed, and a recommended lane. The one or more recommendations can be calculated by a processor of the edge network device and stored in a memory of the edge network device. The edge network device can transmit the one or more calculated recommendations via a wireless link.

At 508, the functionality comprises receiving a calculated recommendation from an edge network device. The calculated recommendation can be based in part on the local crowdsourcing of traffic condition data, vehicle information, and destination data. The calculated recommendation can be received via a wireless network link (e.g., a PC5 link or Uu link). The calculated recommendation can include a route recommendation for optimized travelling time (e.g., driving duration, intersection waiting time). The calculated recommendation can include a route recommendation for optimized fuel consumption including a recommended speed for optimized fuel consumption. The calculated recommendation can include a lane recommendation to avoid unnecessary delays due to traffic conditions. The calculated recommendation can include a compromise solution, which uses one or more weights to provide a compromise between fuel consumption and travel time. In some embodiments, the calculated recommendation is a vehicle speed to maintain through an intersection.

In some embodiments, the edge network device can calculate fuel consumption for one or more routes to a destination. In some embodiments, the fuel consumption for a gasoline driven vehicle is as follows:

$$x = \frac{3014 + 299.3 * a * v - 149 * v + 9.014 * {v}^{2}}{( 3.6 * 742 )}$$

In which, a equals vehicle acceleration in meters per second squared; v is the speed of the vehicle in meters per second, and x equals fuels consumption in milliliters per second.

At 510, the functionality comprises displaying the calculated recommendation on a display of the V2X device. In some embodiments, the V2X device can be a smartphone. In some embodiments, the V2X device can be an electronic device part of the vehicle (e.g., the vehicle navigation system). In some embodiments, the recommendation can be displayed via a heads up display of the vehicle. In some embodiments, the recommendation can be presented to the driver via audio means (e.g., a speaker of the electronic device or a speaker of the vehicle entertainment system).

It should be appreciated that the specific steps illustrated in FIG. 5 provide particular techniques for enhanced navigation techniques according to various embodiments of the present disclosure. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

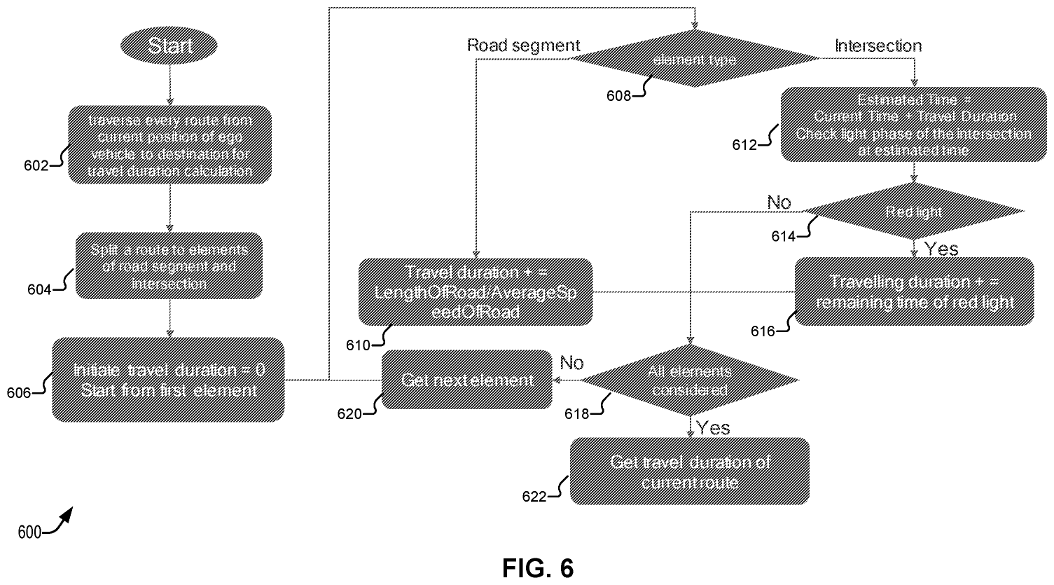

FIG. 6 illustrates a illustrates a process flow diagram of a method 600 for enhanced navigation techniques according to various embodiments. Alternative embodiments may vary in function by combining, separating, or otherwise varying the functionality described in the blocks illustrated in FIG. 6. Means for performing the functionality of one or more of the blocks illustrated in FIG. 6 may comprise hardware and/or software components of an edge network device (e.g., a roadside unit).

At 602, the edge network device accesses the destination of a vehicle from memory. The edge network device will electronically traverse every route from the current position of the vehicle to the destination in order to calculate travel duration.

At 604, the edge network device electronically splits each route into discrete elements of road segment and intersections. The discrete route elements can be identified by a discrete identification number and stored in a memory of the edge network device.

At 606, the edge network device will initiate a simulated travel duration for the route starting at the first element.

At 608, the edge network device identifies the element as either a road segment or an intersection.

At 610, the edge network device identifies the element as a road segment. The travel duration can be calculated as the length of road of the element divided by the average speed of the road. The travel duration for this element can be stored in a memory of the edge network device.

At 612, the edge network device identifies the element as an intersection. The estimated time can be calculated as the current time (at block 606) plus the travel duration to the intersection. The traffic light phase information can be received by the edge network device. The light phase of the intersection at the estimate arrival time can be calculated.

At 614, the edge network device determines if the light at the intersection is red, yellow, or green.

At 616, if the light is red, the edge network device traveling duration is increased by the remaining time of the red light.

At 618, if the light is green, the edge network device determines if all the elements have been considered.

At 620, if there are elements of the route remaining the edge network device retrieves from the memory the next element of the route and proceeds to block 608. If there are no further elements, the technique proceeds to block 622.

At 622, the total travel time for the route can be calculated by adding up all the times for the individual route elements.

It should be appreciated that the specific steps illustrated in FIG. 6 provide particular techniques for calculating segment time according to various embodiments of the present disclosure. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

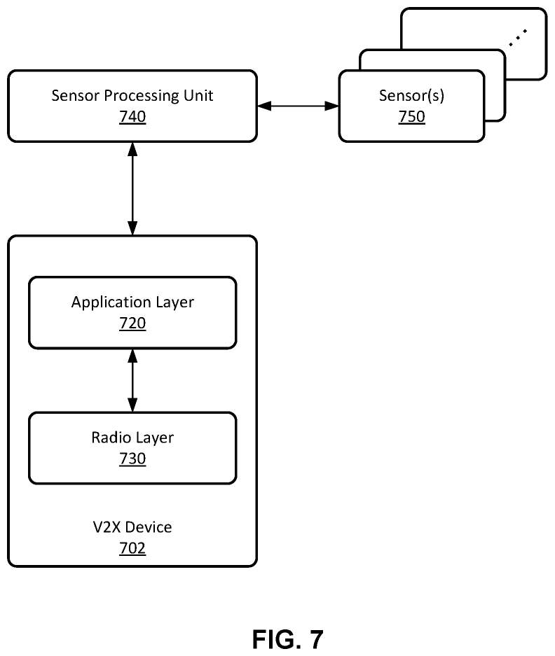

FIG. 7 is a block diagram of a basic architecture of components used to for enhanced navigation techniques as described herein, according to an embodiment. These components comprise a V2X device 702 with an application layer 720 and radio layer 730, a sensor processing unit 740, and one or more sensors 750. As a person of ordinary skill in the art will appreciate, the components illustrated in FIG. 7 may comprise hardware and/or software components and may be executed by different devices, as indicated below.

The V2X device 702 may comprise a device or component used to obtain sensor information, determine an enhanced communication range based thereon, and transmit a V2X message having the enhanced communication range. As such, the V2X device 702 may be located on a transmitting vehicle (e.g., vehicle 106 of FIG. 1, as previously described). That said, some embodiments may not be limited to vehicular V2X devices. And thus, the V2X device 702 may comprise a non-vehicular, V2X-capable device (e.g., at a RSU, VRU, etc.).

The V2X device 702 may comprise hardware and software components, such as those illustrated in FIG. 8 and described below. These components include components capable of executing the application layer 720 and radio layer 730 shown in FIG. 7. For example, the application layer may be implemented by a software application executed by processing unit(s) and memory of the V2X device 702, and is the radio layer 730 may be implemented by software (e.g., firmware) executed at a wireless communication interface of the V2X device.

In short, the application layer 720 may be the layer at which the sensor-based communication range may be determined, based on input from the sensor(s) 750 (e.g., comprising a camera, radar, LIDAR, etc.), which is provided via the sensor processing unit 740. The sensor-processing unit 740 may comprise a general- or special-purpose processor that acts as a central hub for sensor data by receiving and processing sensor data from the sensor(s) 750. In some embodiments, for example, the sensor-processing unit 740 may be capable of receiving and fusing sensor data from the sensor(s) 750 to determine higher-order information. And thus, in some embodiments, the sensor processing unit 740 can provide the application layer 720 of the V2X device 702 with one or more properties of an object detected by the sensor(s) 750 (object type, location, velocity, acceleration, etc.). Additionally or alternatively, raw sensor data may be provided to the V2X device 702, which may make this determination. In some embodiments, therefore, the functionality of the sensor-processing unit 740 may be integrated into the V2X device 702. In some embodiments, as noted, the sensor(s) 750 may be located on a vehicle or device separate from the V2X device 702. In some embodiments, the sensor-processing unit 740, too, can be located on a separate vehicle or device. In such instances, communication between the sensor(s) 750 and sensor-processing unit 740, and/or communication between the sensor-processing unit 740 and V2X device 702 may be via wireless communication means.

The application layer 720 acts as an intermediary between the radio layer 730 and is the sensor(s) 750. As noted, it can determine, based on sensor data as provided via the sensor-processing unit 740, the communication range for a V2X message sent from the V2X device 702 via the radio layer 730. At the radio layer 730, which comprises the physical layer of hardware and software components configured to transmit the V2X message, the determined communication range can be implemented as a Hybrid Automatic Repeat Request (HARQ) feedback distance based on the desired range. As a person of ordinary skill in the art will appreciate, a parameter indicative of the HARQ feedback distance may be included in the V2X message itself; or, the parameter indicative of HARQ feedback distance may be included in signaling accompanying or indicating the V2X message, e.g., sidelink control information. Thus, in some embodiments, the determined communication range may be implemented by including, in the V2X message or corresponding signaling, a parameter indicative of the HARQ feedback distance.

It can be noted, however, that the HARQ feedback distance may not be the same as the determined communication range. In some embodiments, for example, the HARQ feedback distance may be slightly larger than the determined communication range to accommodate some margin. Accordingly, some embodiments may utilize techniques for converting or mapping a determined communication range to a HARQ feedback distance. These can include, increasing the determined communication range by a certain percentage or minimum distance, for example. In another example, the indication of HARQ feedback distance has limitation (e.g., only a limited number of quantized distances can be indicated); the determined communication range is mapped to one of the quantized distances.

According to some embodiments, the radio layer 730 may also be used to determine an appropriate Modulation and Coding Scheme (MCS), based on the communication range determined by the application layer 720 and passed to the radio layer. As a person of ordinary skill in the art will appreciate, the radio layer 730 may use different orders of MCS for transmitting the V2X message. Generally put, more elaborate coding schemes (higher orders of MCS) may be used at shorter ranges, whereas more basic coding schemes are used if the desired ranges longer. Proper MCS selection can be used to help ensure efficient spectrum usage.

FIG. 8 is a block diagram of an embodiment of a V2X device 810, which may be utilized as described herein above. In some embodiments, the V2X device 810 may comprise or be integrated into a vehicle computer system used to manage one or more systems related to the vehicle's navigation and/or automated driving, as well as communicate with other onboard systems and/or other traffic entities. In some embodiments, the V2X device 810 may comprise a stand-alone device or component on a vehicle (or other V2X entity), which may be communicatively coupled with other components/devices of the vehicle (or entity).

As noted, the V2X device 810 may implement the application layer 820 and radio layer 830 illustrated in FIG. 3, and may also perform one or more of the functions of method 500 of FIG. 5, previously described. It should be noted that FIG. 8 is meant only to provide a generalized illustration of various components, any or all of which may be utilized as appropriate. It can be noted that, in some instances, components illustrated by FIG. 8 can be localized to a single physical device and/or distributed among various networked devices, which may be located, for example, at different physical locations on a vehicle.

The V2X device 810 is shown comprising hardware elements that can be electrically coupled via a bus 805 (or may otherwise be in communication, as appropriate). The hardware elements may include a processing unit(s) 810 which can include without limitation one or more general-purpose processors, one or more special-purpose processors (such as digital signal processing (DSP) chips, graphics acceleration processors, application-specific integrated circuits (ASICs), and/or the like), and/or other processing structure or means. As shown in FIG. 8, some embodiments may have a separate Digital Signal Processor (DSP) 820, depending on desired functionality. In embodiments where a sensor-processing unit 840 (as illustrated in FIG. 7 and previously described) is integrated into the V2X device 810, the processing unit(s) 810 may comprise the sensor-processing unit 840.

The V2X device 810 also can include one or more input devices 870, which can include devices related to user interface (e.g., a touch screen, touchpad, microphone, button(s), dial(s), switch(es), and/or the like) and/or devices related to navigation, automated driving, and the like. Similarly, the one or more output devices 815 may be related to interacting with a user (e.g., via a display, light emitting diode(s) (LED(s)), speaker(s), etc.), and/or devices related to navigation, automated driving, and the like.

The V2X device 810 may also include a wireless communication interface 830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device and/or various cellular devices, etc.), and/or the like. The wireless communication interface 830 can enable the V2X device 810 to communicate to other V2X devices, and (as previously noted) may be used to implement the radio layer 830 illustrated in FIG. 7 and described above, to transmit a V2X message with a determined communication range. Communication using the wireless communication interface 830 can be carried out via one or more wireless communication antenna(s) 832 that send and/or receive wireless signals 834.

The V2X device 810 can further include sensor(s) 840. Sensors 840 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like). Sensors 840 may be used, for example, to determine certain real-time characteristics of the vehicle, such as location, velocity, acceleration, and the like. The sensor(s) 840 illustrated in FIG. 8 may include sensor(s) 850 (as illustrated in FIG. 7 and previously described), in instances where sensor data used to detect an object is received from sensors that are co-located on a vehicle (or other V2X entity) with the V2X device 810.

Embodiments of the V2X device 810 may also include a GNSS receiver 880 capable of receiving signals 884 from one or more GNSS satellites using an antenna 882 (which could be the same as antenna 832). Positioning based on GNSS signal measurement can be utilized to determine a current location of the V2X device, and may further be used as a basis to determine the location of a detected object. The GNSS receiver 880 can extract a position of the V2X device 810, using conventional techniques, from GNSS satellites of a GNSS system, such as Global Positioning System (GPS) and/or similar satellite systems.

The V2X device 810 may further comprise and/or be in communication with a memory 860. The memory 860 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 860 of the V2X device 810 also can comprise software elements (not shown in FIG. 8), including an operating system, device drivers, executable libraries, and/or other code, such as one or more application programs, which may comprise computer programs provided by various embodiments, and/or may be designed to implement methods and/or configure systems as described herein. Software applications stored in memory 860 and executed by processing unit(s) 810 may be used to implement the application layer 720 illustrated in FIG. 7 and previously described. Moreover, one or more procedures described with respect to the method(s) discussed herein may be implemented as code and/or instructions in memory 860 that are executable by the V2X device 810 (and/or processing unit(s) 810 or DSP 820 within V2X device 810), including the functions illustrated in the method 500 of FIG. 5 described below. In an aspect, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, any other physical medium with patterns of holes, RAM, a programmable ROM (PROM), erasable programmable ROM (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. In addition, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special-purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special-purpose computer or similar special-purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the various embodiments. In addition, a number of steps may be undertaken before, during, or after the above elements are considered. Accordingly, the above description does not limit the scope of the disclosure.

What is claimed is:

1. A method of providing navigation assistance at a vehicle-to-everything (V2X) device, the method comprising:
receiving an input of a destination for the navigation assistance;
receiving vehicle information, the vehicle information including one or more of acceleration, velocity, and geographic location of a vehicle;
transmitting via a wireless communication link the vehicle information and the destination to one or more edge network devices;
receiving via the wireless communication link a calculated recommendation from the one or more edge network devices, the calculated recommendation based in least in part on local crowdsourcing of traffic condition data; and
displaying the calculated recommendation on a display of the V2X device.

2. The method of claim 1, wherein the wireless communication link is a direct PC5 communication link.

3. The method of claim 1, wherein the wireless communication link is a local Uu interface.

4. The method of claim 1, wherein the calculated recommendation includes a route recommendation.

5. The method of claim 4, wherein the route recommendation is optimized to minimize travel time including driving time and intersection waiting time.

6. The method of claim 4, wherein the route recommendation is optimized to minimize fuel consumption.

7. The method of claim 1, wherein the calculated recommendation is a lane recommendation.

8. The method of claim 1, wherein the calculated recommendation is a vehicle speed recommendation.

9. The method of claim 1, wherein the vehicle information is received via a wired or wireless connection to the vehicle.

10. The method of claim 1, wherein the V2X device comprises a smartphone and the vehicle information is provided by one or more sensors of the smartphone.

11. A vehicle-to-everything (V2X) device comprising:
a transceiver;
a memory; and
one or more processing units communicatively coupled with the transceiver and the memory, the one or more processing units configured to:
receive an input of a destination for navigation assistance;
receive vehicle information, the vehicle information including one or more of acceleration, velocity, and geographic location of a vehicle;
transmit, via the transceiver using a wireless communication link, the vehicle information and the destination to one or more edge network devices;
receive, via the transceiver using the wireless communication link, a calculated recommendation from the one or more edge network devices, the calculated recommendation based in least in part on local crowdsourcing of traffic condition data; and
display the calculated recommendation.

12. The V2X device of claim 11, wherein the transceiver is configured to communicate via a direct PC5 communication link.

13. The V2X device of claim 11, wherein the transceiver is configured to communicate via a local Uu interface.

14. The V2X device of claim 11, wherein the one or more processing units are configured to determine a route recommendation from the calculated recommendation.

15. The V2X device of claim 14, wherein the route recommendation is optimized to minimize travel time including driving time and intersection waiting time.

16. The V2X device of claim 14, wherein the route recommendation is optimized to minimize fuel consumption.

17. The V2X device of claim 11, wherein the one or more processing units are configured to determine a lane recommendation from the calculated recommendation.

18. The V2X device of claim 11, wherein the one or more processing units are configured to determine a vehicle speed recommendation from the calculated recommendation.

19. The V2X device of claim 11, wherein the one or more processing units are configured to receive the vehicle information via a wired or wireless connection to the vehicle.

20. The V2X device of claim 11, wherein the V2X device comprises a smartphone configured to receive the vehicle information via one or more sensors of the smartphone.

21. A device comprising:
means for receiving an input of a destination for navigation assistance;
means for receiving vehicle information, the vehicle information including one or more of acceleration, velocity, and geographic location of a vehicle;
means for transmitting via a wireless communication link the vehicle information and the destination to one or more edge network devices;
means for receiving via the wireless communication link a calculated recommendation from the one or more edge network devices, the calculated recommendation based in least in part on local crowdsourcing of traffic condition data; and
means for displaying the calculated recommendation on a display.

22. The method of claim 21, wherein the means for transmitting comprise means for transmitting via a direct PC5 communication link.

23. The method of claim 21, wherein the means for transmitting comprise means for transmitting via a local Uu interface.

24. The method of claim 21, further comprising means for determining, from the calculated recommendation, a route recommendation.

25. The method of claim 24, wherein the route recommendation is optimized to minimize travel time including driving time and intersection waiting time.

26. The method of claim 24, wherein the route recommendation is optimized to minimize fuel consumption.

27. The method of claim 21, further comprising means for determining, from the calculated recommendation, a lane recommendation.

28. The method of claim 21, further comprising means for determining, from the calculated recommendation, a vehicle speed recommendation.

29. The method of claim 21, further comprising means for receiving the vehicle information via a wired or wireless connection to the vehicle.

30. A non-transitory computer-readable medium storing instructions for providing navigation assistance at a vehicle-to-everything (V2X) device, the instructions when executed on a processor perform operations comprising code for:
receiving an input of a destination for the navigation assistance;
receiving vehicle information, the vehicle information including one or more of acceleration, velocity, and geographic location of a vehicle;
transmitting via a wireless communication link the vehicle information and the destination to one or more edge network devices;
receiving via the wireless communication link a calculated recommendation from the one or more edge network devices, the calculated recommendation based in least in part on local crowdsourcing of traffic condition data; and
displaying the calculated recommendation on a display of the V2X device.
